(19) United States
(12) Patent Application Publication
(10) Pub. No.: US 2013/0180592 A1
(43) Pub. Date: Jul. 18, 2013

(54) Valve for Use in Chemical Injectors and the Like

(71) Applicants: Zhi Yong He, Cypress, TX (US); James Holt, Willis, TX (US); Robert Rees, Houston, TX (US); Gerald Whitley, Conroe, TX (US); Kyle Meier, Katy, TX (US)

(72) Inventors: Zhi Yong He, Cypress, TX (US); James Holt, Willis, TX (US); Robert Rees, Houston, TX (US); Gerald Whitley, Conroe, TX (US); Kyle Meier, Katy, TX (US)

(73) Assignee: Baker Hughes Incorporated, Houston, TX (US)

(21) Appl. No.: 13/456,309

(22) Filed: Apr. 26, 2012

Related U.S. Application Data
(60) Provisional application No. 61/533,323, filed on Sep. 12, 2011.

(51) Int. Cl. F16K 17/04; F16K 17/06; F16K 15/02

(52) U.S. Cl. CPC F16K 17/046; F16K 15/025; F16K 17/06
USPC 137/1; 137/512.5; 137/540

(57) ABSTRACT

A valve having an outer housing defining a central bore with a fluid inlet and a fluid outlet. A check dart assembly, valve seat and piston assembly are retained within the central bore. The valve is moveable between open and closed positions in response to fluid flow into the fluid inlet of the valve.

The present application claims priority to U.S. provisional patent application Ser. No. 61/533,323 filed Sep. 12, 2011.

### BACKGROUND OF THE INVENTION

1. Field of the Invention

The present invention generally relates to check valves.

2. Description of the Related Art

A common form of check valve is a ball member that is biased against a valve seat by a spring. Check valves are used to provide one way flow in a wide variety of applications, including chemical injection devices. Cavitation of fluid passing through the check valve can cause undesirable erosion of the check valve ball and seat.

### SUMMARY OF THE INVENTION

The present invention provides improved check valve designs that reduce fluid cavitation. In addition, the design of the valve reduces erosion around the valve seat.

### BRIEF DESCRIPTION OF THE DRAWINGS

The advantages and other aspects of the invention will be readily appreciated by those of skill in the art and better understood with further reference to the accompanying drawings in which like reference characters designate like or similar elements throughout the several figures of the drawings and wherein:

FIG. 1 is a side, cross-sectional view of an exemplary valve constructed in accordance with the present invention, with the valve in a closed position.

FIG. 2 is a side, cross-sectional view of the valve shown in FIG. 1, now in an open position.

FIG. 3 is an enlarged, side cross-sectional view of portions of an exemplary piston assembly used in the valve of FIGS. 1-2.

FIG. 4 is a side, cross-sectional view depicting two alternative piston assemblies.

FIGS. 5A, 5B and 5C are a side, cross-sectional view of an alternative embodiment for an exemplary valve constructed in accordance with the present invention.

### DETAILED DESCRIPTION OF THE PREFERRED EMBODIMENTS

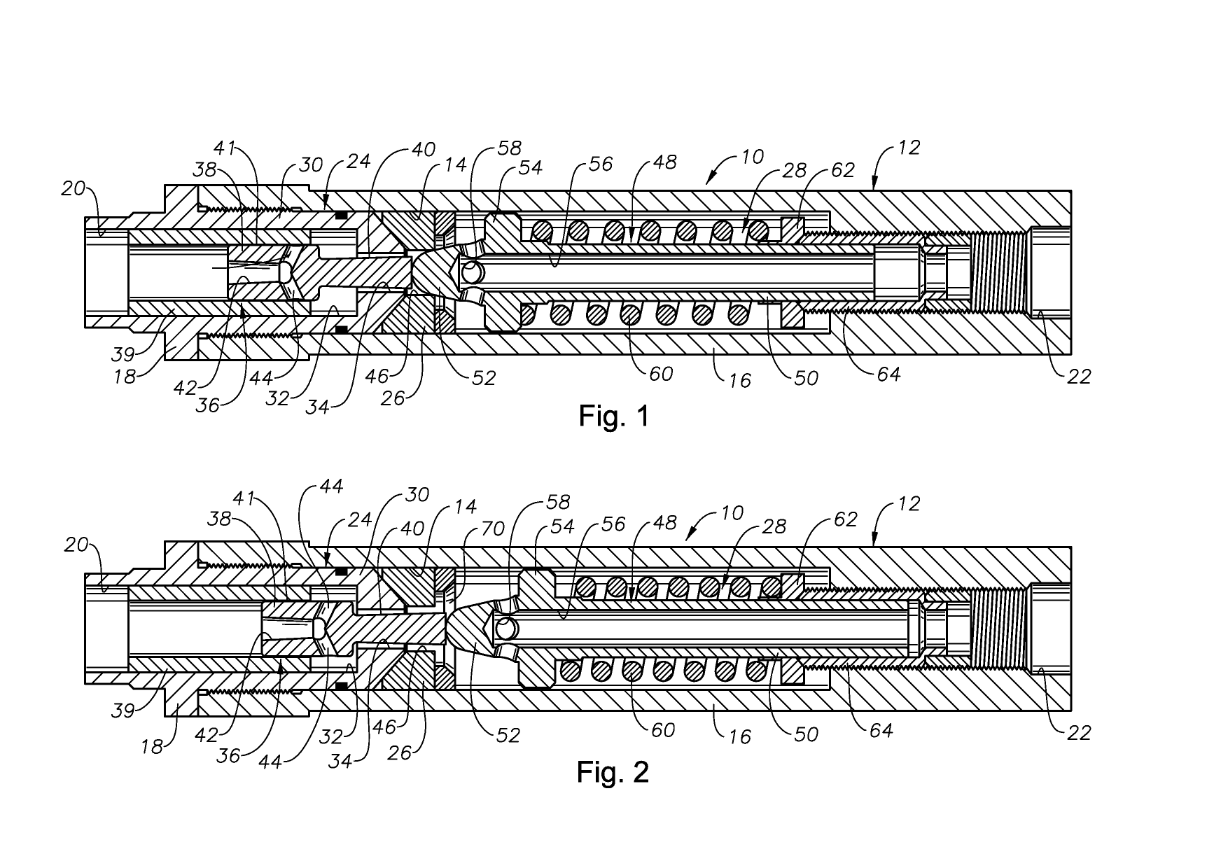

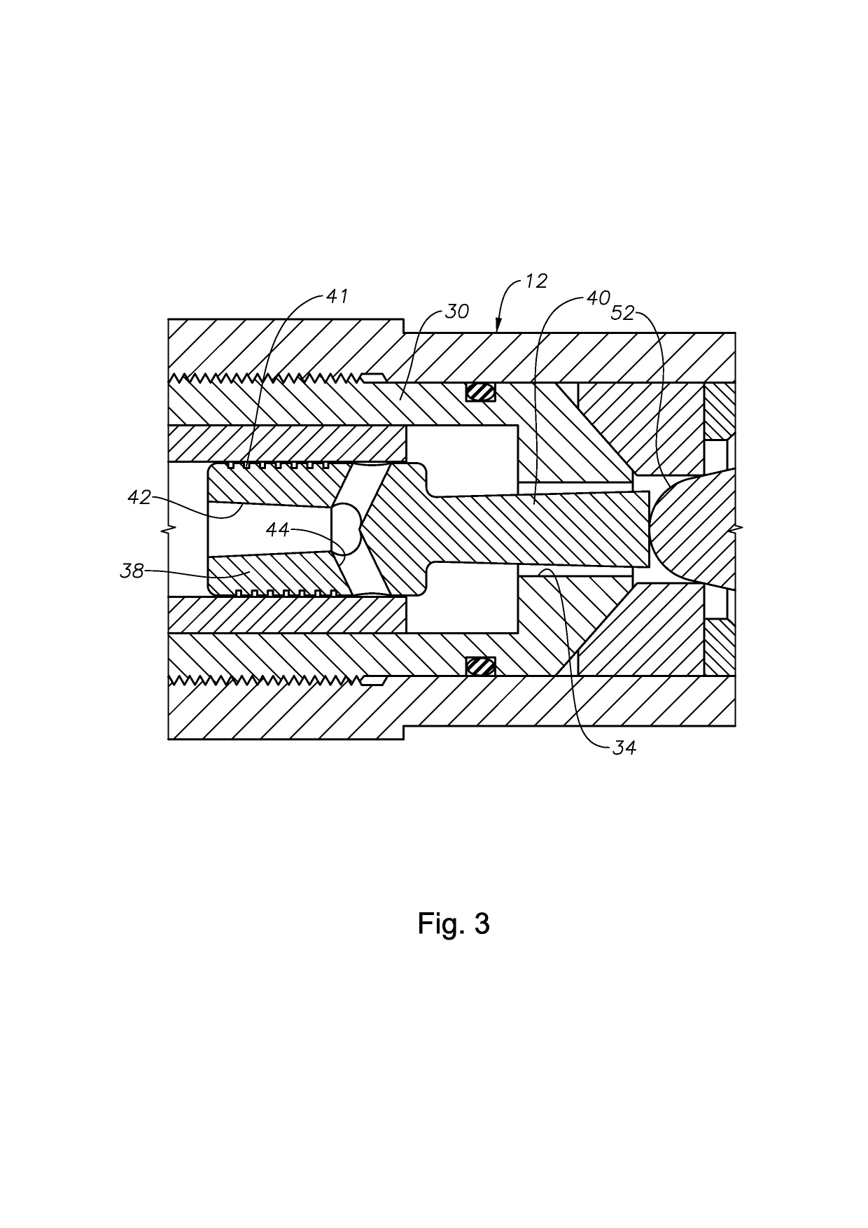

FIGS. 1-2 illustrate an exemplary valve 10 which has been constructed in accordance with the present invention. The valve 10 includes an outer housing 12 that defines an inner axial bore 14 along its length. In the depicted embodiment, the housing 12 is made up of a primary housing member 16 and an affixed cap 18. Axial ends of the housing 12 provide a fluid inlet 20 and a fluid outlet 22. The housing 12 may be provided with suitable threaded end portions (not shown) for incorporation of the valve into a flow line or other fluid flow path.

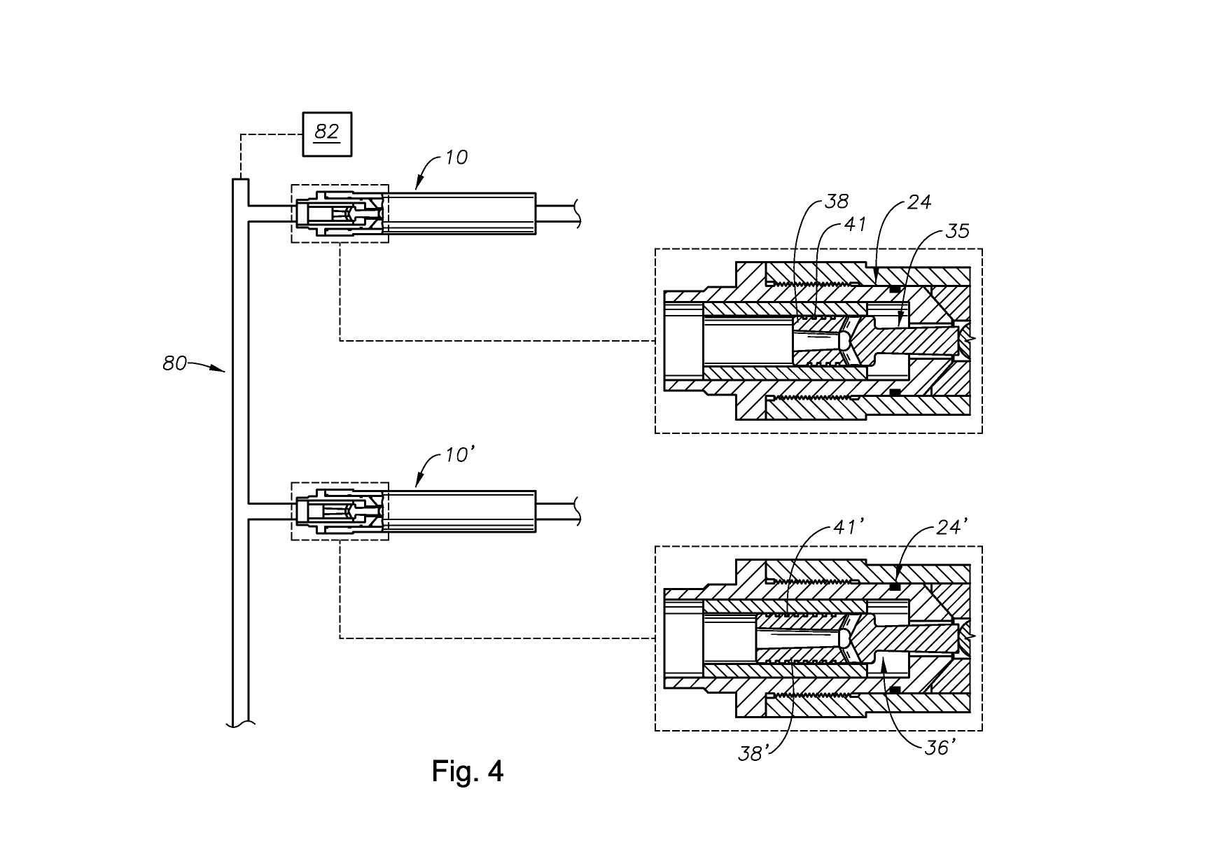

The axial bore 14 generally contains a piston assembly 24, a valve seat 26, and a check dart assembly 28. The piston assembly 24 includes a piston housing 30 that defines an enlarged-diameter inner chamber 32 and a reduced-diameter inner chamber 34. The piston housing 30 is fixedly secured within the bore 14. Piston member 36 is moveably disposed within the inner chambers 32, 34. The piston member 36 includes an enlarged base portion 38 and a reduced-diameter prong portion 40 that extends axially from the base portion 38. The prong portion 40 presents a curved distal end face 43. In the depicted embodiment, an axial flow passage 42 and a plurality of lateral flow passages 44 are formed within the enlarged base portion 38 of the piston member 36. A generally cylindrical sleeve 39 is fixedly disposed within the bore 14 and radially surrounds the base portion 38 of the piston member 36. When the valve 10 is in the closed position, the lateral flow passages 44 are closed off by the sleeve 39. In a preferred embodiment, the base portion 38 of the piston member 36 presents an outer radial surface 41 that is roughened in order to provide increased frictional resistance against movement with respect to the sleeve 39. In one embodiment, the radial surface 41 is roughened by threading, as depicted in FIG. 3. The threading permits some fluid to be transmitted across the piston member 36 via the threads.

The downstream end of the piston housing 30 abuts the valve seat 26. The valve seat 26 defines a reduced-diameter flow passage 46. The prong portion 40 of the piston member 36 is shaped and sized to pass through the flow passage 46 loosely such that fluid may flow around the prong portion 40 (see FIG. 2).

The check dart assembly 28 includes a check dart 48 that has an elongated shaft portion 50 and a head portion 52. An outwardly projecting flange 54 is located between the shaft and head portions 50, 52. An axial bore 56 is defined along the length of the shaft portion 50. The head portion 52 is preferably conically shaped and has lateral flow openings 58 disposed therein which are in communication with the bore 56.

The check dart assembly 28 also includes a compression spring 60 that radially surrounds the shaft portion 50 of the check dart 48. The spring 60 axially abuts the flange 54 at one end and an adjustment member or adjustment nut 62, which lies radially outside of the shaft portion 50, at the other axial end. The adjustment nut 62 is engaged by loose threading with the shaft portion 50 and the nut 62 may be rotated with respect to the shaft portion 50 in order to adjust axial compression loading on the spring 60. A locking nut 64 also radially surrounds the shaft portion 50 and is engaged by threading with the shaft portion 50. The locking nut 64 may be rotated with respect to the shaft portion 50 in order to secure the adjustment nut 62 in place axially upon the shaft portion 50. Due to the bias provided by the spring 60, the head portion 52 of the check dart 48 is in continuous contact with the curved end face 43 of the prong portion 40 of the piston member 36.

The valve 10 may be moved from the closed position (FIG. 1) to the open position (FIG. 2) by fluid flow into the valve 10. In the closed position, the head portion 52 of the check dart 48 is in contact with the valve seat 26, thereby closing off the flow passage 46 against fluid flow therethrough. Fluid is flowed into the valve 10 via the fluid inlet 20. Upon encountering the piston member 36, the fluid exerts pressure against the upstream end of the piston member 36. Movement of the piston member 36 will compress the spring 60 and push the head portion 52 of the check dart 48 off the valve seat 26. Movement of the piston member 36 unblocks the lateral flow passages 44 by moving them out of the surrounding sleeve 39. Fluid can flow through the flow passages 42, 44 and the flow passage 46 of the valve seat 26. Fluid then flows into the lateral flow openings 58 and the axial bore 56 of the check dart 48. The fluid can then flow out of the fluid outlet 22 of the valve 10.

In particular embodiments, the flow patterns provided by the valve 10 reduce cavitation of fluid passing through the valve 10. The sleeve 39 is used to block flow through lateral passages 44 until the check dart 48 is lifted off of the valve seat 26. Proper placement of the lateral passages 44 within the base portion 38 of the piston member 36 will allow the head portion 52 of the check dart 48 to have an increased clearance of the valve seat 26 as flow through the passage 46 of the valve seat 26 occurs. As a result, a wider gap (70 in FIG. 2) is provided for the fluid to flow through, thereby reducing fluid cavitation proximate the passage 46. As cavitation is reduced, damage from erosion around the valve seat 26 is reduced.

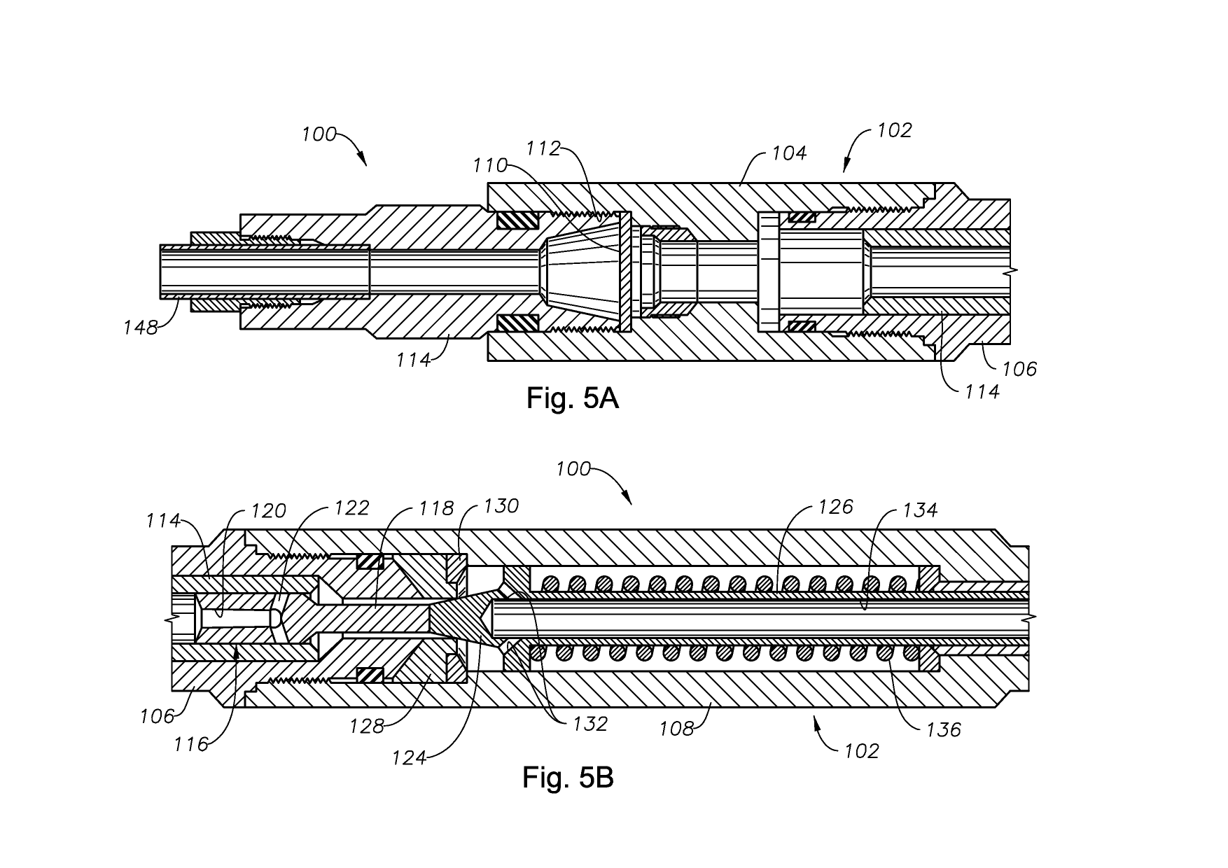

Also, the design of the valve 10 allows selective adjustment of the force required to open the valve 10 by rotation of the adjustment nut 62 to increase or decrease a pre-compressive force to the spring 60. As the spring 60 is compressed by rotation of the adjustment nut 62, the force required to open the valve 10 is increased. Conversely, as the spring 60 is uncompressed by opposite rotation of the adjustment nut 62, the force required to open the valve 10 is reduced.

Where a roughened radial surface 41 is used for the valve 10, the opening force for a particular valve 10 may be adjusted by altering the length of the base portion 38 of the piston member 36 or, at least, the length of the roughened radial surface 41 of the base portion 38. FIG. 4 is an enlarged detail drawing depicting an exemplary valve system 80 having two valves 10, 10′ which are interconnected in parallel with a single fluid source, shown schematically at 82. There may be more than two such valves 10, 10′ in a given system 80. The valve system 80 could be representative of a wellbore chemical injection system wherein the two valves 10, 10′ are chemical injectors at different locations within a wellbore for injection of chemicals into the formation surrounding the wellbore. FIG. 4 presents enlarged cross-sectional views of the piston assemblies 24, 24′ of the two valves 10, 10′. The piston assembly 24 of valve 10 has a piston member 36 with a base portion 38 that presents a roughened outer surface 41. The piston assembly 24′ of valve 10′ has a piston member 36′ with an elongated base portion 38′ that presents roughened radial surface 41′. The roughened radial surface 41′ has a greater axial length than the radial surface 41. As a result, the piston assembly 24′ provides a greater frictional resistance to moving its piston member 36 than does the piston assembly 24 of valve 10. It will require greater fluid pressure to move the piston member 38′ within valve 10′ than the piston member 38 of valve 10. For this reason, the valve 10 can be opened at a first fluid pressure, and the valve 10′ can be opened only at a second fluid pressure that is greater than the first fluid pressure. By altering the axial length of the roughened radial surface, one can control the fluid pressure required to open a particular valve. It should be understood that, while only two valves 10, 10′ are shown, the system 80 might include third, fourth and additional valves, each having their own opening fluid pressure requirement. Such as system 80 would permit, for example, chemicals to be injected into one or more first well zones at a first fluid pressure, but not inject into a second group of well zones. At a higher fluid pressure, chemicals are injected into both the first and second groups of well zones.

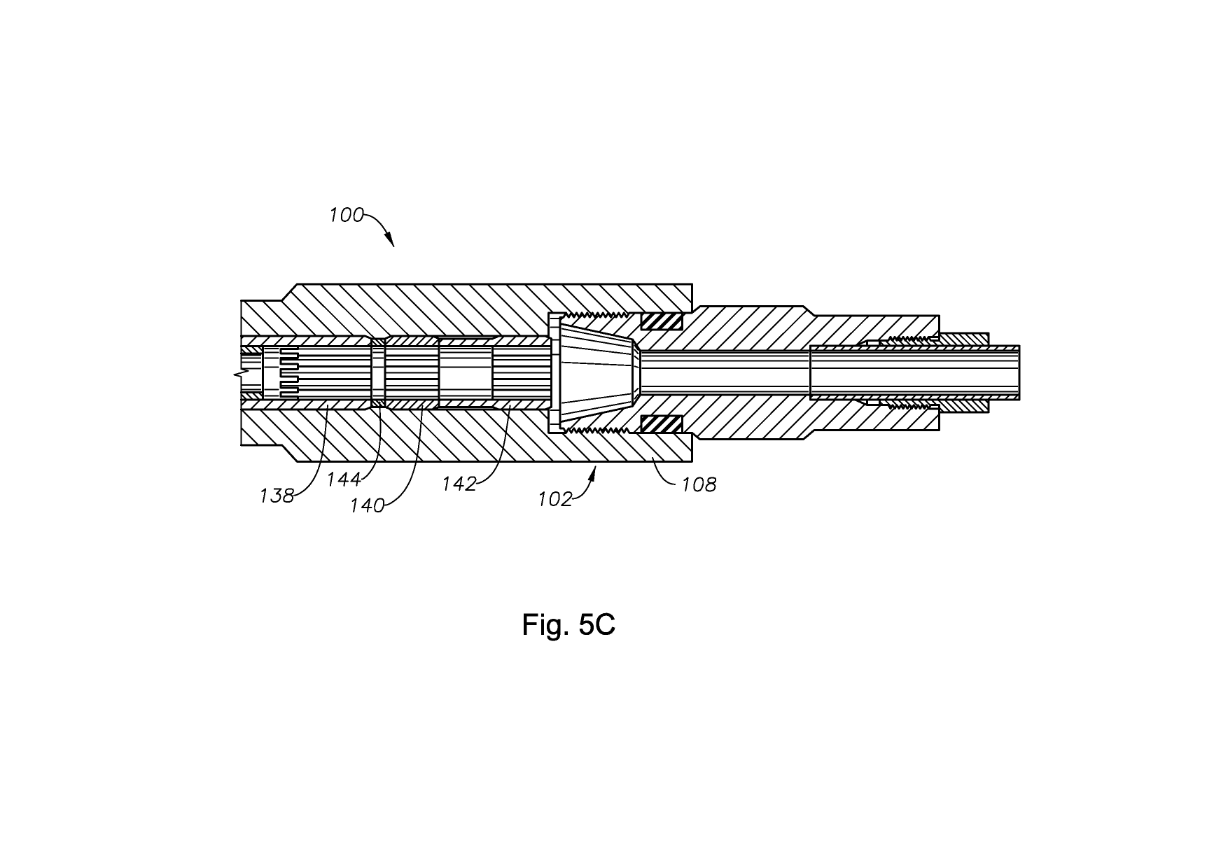

FIGS. 5A, 5B and 5C depict an alternative valve 100 constructed in accordance with the present invention. Except where indicated otherwise, the valve 100 is constructed and operates in the same manner as the valve 10 previously described. The valve 100 includes an outer housing 102 that, in the depicted embodiment, is made up of an upper sub 104, intermediate sub 106 and a lower sub 108. A frangible burst disc 110 is secured within the inlet 112 of the upper sub 104 by a jam nut 114 that is threaded into the inlet 112. The burst disc 110 is designed to rupture when it encounters a predetermined fluid pressure differential. The intermediate sub 106 houses sleeve 114 which is similar to sleeve 39 described previously. Piston 116 is similar to piston 36 and presents prong portion 118. An axial flow passage 120 and lateral flow passages 122 are formed within the piston 116. The prong portion 118 contacts the head portion 124 of check dart 126. A valve seat is provided by an annular check pad 128. The check pad 128 is preferably formed of a durable thermoplastic polymer material such as PEEK (polyether ether ketone). An annular metallic ring 130 is preferably disposed between the check pad 128 and the check dart 126.

The check dart 126 is similar to the check dart 48 described previously. Lateral flow openings 132 and bore 134 are defined within the check dart 126. Spring 136 is similar to the spring 60 described previously. The adjustment nut 138 is similar to the adjustment nut 62 described earlier. The valve 100 is also provided with a pair of locking nuts 140, 142. In the depicted embodiment, the locking nut 140 has a standard, right-handed thread. The locking nut 142 has a left-handed thread. A spacer ring 144 is located between the adjustment nut 138 and the locking nut 140 to help prevent the transmission of torque from the locking nut 142 to the adjustment nut 138. A user can rotate the adjustment nut 138 to adjust axial compression loading on the spring 136. Thereafter, the adjustment nut 138 is secured in place by tightening the first locking nut 140 and spacer ring 144 up against the adjustment nut 138. Then, the second locking nut 142 is rotated and tightened up against the first locking nut 140. The use of two, oppositely-threaded locking nuts 140, 142 helps prevent inadvertent loosening of the adjustment nut 138.

In operation, fluid is flowed toward the valve 100 along fluid conduit 148. No fluid will enter the valve 100 due to the presence of burst disc 110. After fluid pressure has been increased to create a sufficient pressure differential across the disc 110, the disc 110 will rupture, allowing fluid to enter the valve 100. The valve 100 will open and close in largely the same manner as the valve 10 described earlier.

Those of skill in the art will recognize that numerous modifications and changes may be made to the exemplary designs and embodiments described herein and that the invention is limited only by the claims that follow and any equivalents thereof.

What is claimed is:

1. A valve comprising:
an outer housing defining a central bore with a fluid inlet and a fluid outlet;
a check dart assembly retained within the bore and having a check dart with a head portion and a shaft portion, the shaft portion defining an axial flow bore and the head portion having a fluid passage to permit fluid flow into the axial flow bore of the shaft portion;
a valve seat retained within the central bore of the outer housing and having a flow passage that is selectively opened and closed by the check dart; and
a piston assembly retained within the central bore of the outer housing, the piston assembly having a piston member that extends through the valve seat flow passage and contacts the check dart, the piston member being moveable in response to fluid pressure to open the flow passage of the valve seat by moving the check dart.

2. The valve of claim 1 wherein the check dart assembly further comprises a spring that biases the check dart into engagement with the valve seat to close the valve seat flow passage.

3. The valve of claim 1 wherein the piston member of the piston assembly further comprises:
an enlarged base portion;
a prong portion extending axially from the base portion; and
an axial flow passage defined within the base portion.

4. The valve of claim 3 further comprising a lateral flow passage formed within the base portion.

5. The valve of claim 4 further comprising:
a sleeve radially surrounding the enlarged base portion and wherein the sleeve blocks fluid flow through the lateral flow passage when the valve is closed and allows fluid flow through the lateral flow passage when the valve is open.

6. The valve of claim 2 further comprising:
an adjustment member that compresses or uncompresses the spring to selectively adjust the force required to open the valve.

7. The valve of claim 3 wherein the prong portion presents a curved distal end face that is in contact with the check dart.

8. A valve comprising:
an outer housing defining a central bore with a fluid inlet and a fluid outlet;
a check dart assembly retained within the bore and having a check dart with a head portion and a shaft portion, the shaft portion defining an axial flow bore and the head portion having a fluid passage to permit fluid flow into the axial flow bore of the shaft portion;
a valve seat retained within the central bore of the outer housing and having a flow passage that is selectively opened and closed by the check dart;
a piston assembly retained within the central bore of the outer housing, the piston assembly having a piston member that extends through the valve seat flow passage and contacts the check dart, the piston member being moveable in response to fluid pressure to open the flow passage of the valve seat by moving the check dart; and
a spring that biases the check dart into engagement with the valve seat to close the valve seat flow passage.

9. The valve of claim 8 wherein the piston member of the piston assembly further comprises:
an enlarged base portion;
a prong portion extending axially from the base portion; and
an axial flow passage defined within the base portion.

10. The valve of claim 9 further comprising a lateral flow passage formed within the base portion.

11. The valve of claim 10 further comprising:
a sleeve radially surrounding the enlarged base portion and wherein the sleeve blocks fluid flow through the lateral flow passage when the valve is closed and allows fluid flow through the lateral flow passage when the valve is open.

12. The valve of claim 8 further comprising:
an adjustment member that compresses or uncompresses the spring to selectively adjust the force required to open the valve.

13. The valve of claim 12 further comprising a locking member to secure the adjustment member in place.

14. The valve of claim 9 wherein the prong portion presents a curved distal end face that is in contact with the check dart.

15. A method of operating a valve comprising:
lifting a check dart off a valve seat; and
thereafter, unblocking a flow passage in a piston that is axially in contact with the check dart to permit fluid to flow through the valve seat.

16. The method of claim 15 wherein the step of unblocking a flow passage comprises urging the piston through a sleeve radially surrounding piston so that a lateral fluid passage in the piston is unblocked, and fluid can flow through the piston.

17. The method of claim 16 wherein fluid flowing through the piston will pass through the valve seat after flowing through the piston.

18. The method of claim 17 wherein:
an axial bore is defined within the check dart; and
fluid passing through the valve seat will enter and flow along the axial bore.

19. The method of claim 15 wherein the step of lifting a check dart off a valve seat further comprises:
flowing fluid against the piston to move the piston within a surrounding housing; and
wherein movement of the piston within the housing urges the check dart off the valve seat.
